(19) United States
(12) Patent Application Publication
(10) Pub. No.: US 2025/0309764 A1
(43) Pub. Date: Oct. 2, 2025

(54) SWITCHING CONVERTER GROUND DAMPING

(71) Applicant: Texas Instruments Incorporated, Dallas, TX (US)

(72) Inventors: Thomas KELLER, Attenkirchen (DE); Awais YAQOOB, Freising (DE); Ricardo NUNES, Freising (DE); Markus ROMMEL, Freising (DE)

(73) Assignee: Texas Instruments Incorporated, Dallas, TX (US)

(21) Appl. No.: 18/620,570

(22) Filed: Mar. 28, 2024

(51) Int. Cl. H02M 3/155

(52) U.S. Cl. CPC H02M 3/155

(57) ABSTRACT

A circuit includes a first ground terminal, a second ground terminal, an output terminal, a transistor, a controller, and a resistor. The output terminal is configured to provide an output voltage. The transistor has a first terminal coupled to the output terminal, a second terminal coupled to the first ground terminal, and a control terminal. The controller has an output coupled to the control terminal, and a reference terminal coupled to the second ground terminal. The resistor has a first terminal coupled to the second terminal of the transistor, and a second terminal coupled to the reference terminal.

### BACKGROUND

A switching converter is an electronic circuit that converts an input direct current (DC) voltage into one or more DC output voltages that are higher or lower in magnitude than the input DC voltage. A switching converter that generates an output voltage lower than the input voltage is termed a buck or step-down converter. A switching converter that generates an output voltage higher than the input voltage is termed a boost or step-up converter.

Some switching converter topologies include a drive/power switch coupled at a switch node to an energy storage inductor/transformer. Electrical energy is transferred through the energy storage inductor/transformer to a load by alternately opening and closing the switch as a function of a switching signal. The voltage present at the load is a function of the ON/OFF duty cycle of the switch, Switching converters are widely used in electronic devices, particularly battery powered devices, such as portable cellular phones, laptop computers, and other electronic systems in which efficient use of power is desirable.

### SUMMARY

In one example, a circuit includes a first ground terminal, a second ground terminal, an output terminal, a transistor, a controller, and a resistor. The output terminal is configured to provide an output voltage. The transistor has a first terminal coupled to the output terminal, a second terminal coupled to the first ground terminal, and a control terminal. The controller has an output coupled to the control terminal, and a reference terminal coupled to the second ground terminal. The resistor has a first terminal coupled to the second terminal of the transistor, and a second terminal coupled to the reference terminal.

In another example, a circuit includes a first ground terminal, a second ground terminal, an output terminal, a transistor, a controller, anti-parallel diodes, and a resistor. The output terminal is configured to provide an output voltage. The transistor has a first terminal coupled to the output terminal, a second terminal coupled to the first ground terminal, and a control terminal. The controller has an output coupled to the control terminal, and a reference terminal. The anti-parallel diodes are coupled between the reference terminal and the second terminal of the transistor. The resistor is coupled between the reference terminal and the second ground terminal.

In a further example, an integrated circuit includes a semiconductor die. The semiconductor die includes a first ground terminal, a second ground terminal, an output terminal, a transistor, a controller, a first resistor, and a second resistor. The output terminal is configured to provide an output voltage. The transistor has a first terminal coupled to the output terminal, a second terminal coupled to the first ground terminal, and a control terminal. The controller has an output coupled to the control terminal, and a reference terminal. The first resistor has a first terminal coupled to the second terminal of the transistor, and a second terminal coupled to the reference terminal. The second resistor has a first terminal coupled to the reference terminal, and a second terminal coupled to the second ground terminal.

### BRIEF DESCRIPTION OF THE DRAWINGS

FIG. 1 is a schematic diagram of an example switching converter that includes ground damping.

FIG. 2 is a graph of example signals in a switching converter that lacks ground damping.

FIG. 3 is a graph of example signals in the switching converter of FIG. 1.

FIG. 4 is a graph of example signals in a switching converter that includes a resistor in parallel with protection diodes between ground terminals.

FIG. 5 is a graph of example signals in switching converter that includes resistor in series with an analog ground terminal.

### DETAILED DESCRIPTION

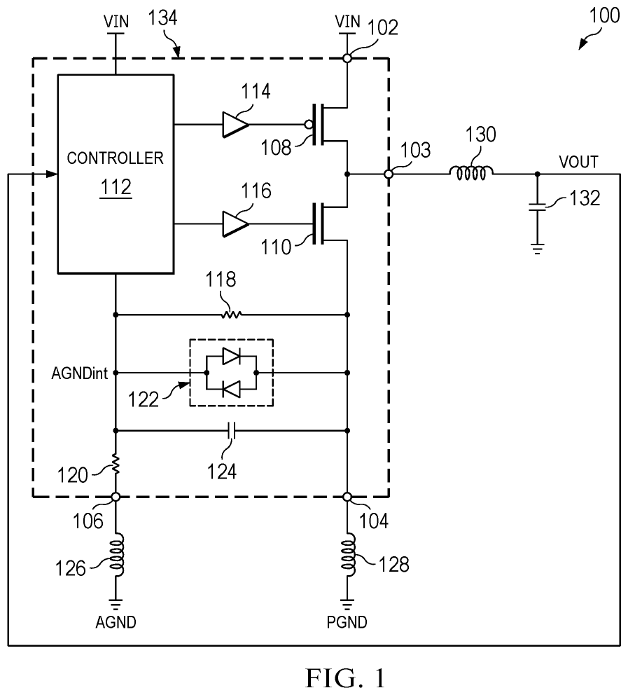

FIG. 1 is a schematic diagram of an example switching converter 100 that includes ground damping. The switching converter 100 includes transistors 108 and 110, a controller 112, drivers 114 and 116, anti-parallel diodes 122, and resistors 118 and 120. In some implementations of the switching converter 100, the transistors 108 and 110, the controller 112, the drivers 114 and 116, the anti-parallel diodes 122, the resistors 118 and 120, and other circuits and components of the switching converter 100 may be provided on semiconductor die 134 (e.g., a silicon die) of an integrated circuit. The transistor 108 may be a p-channel field effect transistor (PFET) and the transistor 110 may be an n-channel field effect transistor (NFET). The transistor 108 has a first terminal (e.g., source) coupled to an input terminal 102 (an input voltage terminal). The input terminal 102 can provide a power supply voltage to the switching converter 100. A second terminal (e.g., drain) of the transistor 108 is coupled to a first output terminal 103 (an output voltage terminal). A control terminal (e.g., gate) of the transistor 108 is coupled to a first output of the controller 112 via the driver 114.

The transistor 110 has a first terminal (e.g., drain) coupled to the output terminal 103 and the second terminal of the transistor 108, and a second terminal (e.g., source) coupled to a ground terminal 104 (a power ground terminal). A control terminal (e.g., gate) of the transistor 110 is coupled to a second output of the controller 112 via the driver 116. The output terminal 103 is coupled to a first terminal of an inductor 130. A second terminal of the inductor 130 is coupled to a first terminal of a capacitor 132. An output voltage of the switching converter 100 is provided at the first terminal of the capacitor 132. A second terminal of the capacitor 132 is coupled to a reference terminal (e.g., ground) provided on a circuit substrate, such as a printed circuit board. The first terminal of the capacitor 132 is also coupled to an input of the controller 112 to provide a feedback voltage to the controller 112.

The controller 112 generates signals (e.g., pulse width modulation signals) that control switching of the transistor 108 and transistor 110 based on the feedback voltage. For example, the controller 112 may include circuitry (e.g., an error amplifier) that compares the feedback voltage to a reference voltage to generate an error signal. The controller 112 may control switching of the transistor 108 and the transistor 110 based on the error signal.

The controller 112 has a reference terminal that is coupled to a ground terminal 106 (analog ground terminal). An electrostatic discharge (ESD) protection circuit, such as the anti-parallel diodes 122, is coupled between the reference terminal and the second terminal of the transistor 110. The anti-parallel diodes 122 includes first and second diodes. The first diode has an anode coupled to the second terminal of the transistor 110, and a cathode coupled to the reference terminal of the controller 112. The second diode has an anode coupled to the reference terminal of the controller 112, and a cathode coupled to second terminal of the transistor 110.

A parasitic inductor 126, formed by the packaging and lead frame of the integrated circuit, and conductors of a circuit board on which the integrated circuit is mounted, is coupled between the ground terminal 106 and analog ground (AGND). Similarly, a parasitic inductor 128, formed by the packaging, lead frame, and circuit board conductors, is coupled between the ground terminal 104 and power ground (PGND). AGND and PGND may be connected on a circuit substrate, such as a printed circuit board, on which a packaged integrated circuit including the semiconductor die 134 is mounted.

The transistor 110 may conduct relatively large currents when switching (e.g., tens of amperes), which can produce substantial switching noise. The PN junctions formed by n-type areas of the transistor 110 in a p-type substrate connected to an internal analog ground (AGNDint) produce relatively large parasitic capacitors. These parasitic capacitors are shown in the switching converter 100 as the parasitic capacitor 124 coupled between the reference terminal of the controller 112 and the second terminal of the transistor 110. The parasitic capacitor 124, the parasitic inductor 126, and the parasitic inductor 128 form a resonant inductor-capacitor (L-C) tank. When the transistor 108 is turned off and the transistor 110 is turned on, the current flowing in the parasitic inductor 128 changes, which triggers oscillation in the L-C tank. Because the parasitic capacitor 124, parasitic inductor 126, and parasitic inductor 128 have relatively good quality factors (e.g., low losses), the oscillation is only slightly damped, and may take a relative long time to dissipate (e.g., decrease in amplitude to a selected percentage (e.g. 10 percent) of the maximum oscillation amplitude).

The oscillation in the L-C tank appears on the ground terminal 106. The analog ground reference provided at the ground terminal 106 establishes a reference for operation of circuits in the controller 112, and is intended to be relatively noise-free. The oscillation can degrade the operation of the circuits of the controller 112. For example, the oscillation may cause a comparator in the controller 112 to trigger, which causes an error in the control of the transistor 108 and the transistor 110. Some examples of the controller 112 include blanking circuitry configured to prevent operation of selected circuitry of the controller 112 when the oscillation is present. During a blanking interval generated by the blanking circuitry, the controller 112 makes no switching decisions. However, blanking can limit the minimum on-time, or duty cycle of the switching converter 100, which can limit the minimum output voltage of the switching converter 100. In buck converters, output voltage is a function of duty cycle. Accordingly, use of long blanking times, as needed to prevent errors caused by oscillation on the ground terminal 106 of the switching converter 100, can inhibit generation of the relatively low voltages needed to power some logic circuits, such as processor cores.

The switching converter 100 includes a damping network coupled to the ground terminals 104 and 106 to damp the oscillation in the L-C tank. In the example of the switching converter 100 shown in FIG. 1, the damping network includes the resistors 118 and 120. The resistors 118 and 120 damp the oscillation in the L-C tank to substantially reduce the time that ringing caused by switching of the transistor 110 is present on the analog ground and the reference terminal of the controller 112. With the duration of oscillation reduced, any blanking time implemented by the controller 112 can be reduced, which allows the controller 112 to provide shorter on-times (for the transistor 108), and lower output voltages for a given frequency of operation. The resistor 118 has a first terminal coupled to the second terminal of the transistor 110, and a second terminal coupled to the reference terminal of the controller 112. The resistor 120 has a first terminal coupled to the reference terminal of the controller 112 and a second terminal coupled to the ground terminal 106. The resistance of the resistor 118 may be selected to provide damping of the oscillation while not providing too low a resistive connection between the power ground and the analog ground. For example, if the resistance of the resistor 118 is too low, then all (or at least a substantial portion) of the noise present on the reference terminal 104 (PGND) may be visible on the reference terminal 106 (AGND), which should be avoided. In some examples of the switching converter 100, the resistor 118 may have a resistance of about 5 ohms. In some examples of the switching converter 100, the resistor 118 may have a resistance of about 3 to 7 ohms, or about 3-20 ohms. The resistance of the resistor 120 may be selected to provide damping of the oscillation with an acceptable DC voltage drop. In some examples of the switching converter 100, the resistor 120 may have a resistance of about 0.2 ohms. In some examples of the switching converter 100, the resistor 120 may have a resistance of about 0.01 to 0.5 ohms, or about 0.01 to 1 ohms. For example, if the resistance of resistor 120 is too large, the resulting difference in voltage drops for different operating conditions of the controller 112 with different bias currents through the reference terminal 106 could significantly change an internal reference voltage generated by a bandgap reference circuit of the controller 112, and consequently impact the accuracy of the output voltage of the switching converter 100.

While the switching converter 100 has been illustrated as a buck converter, other examples of the switching converter 100 may be boost, buck-boost, or other types of switching converters that include the resistors 118 and/or 120 to dampen oscillation at the reference terminal of the controller 112.

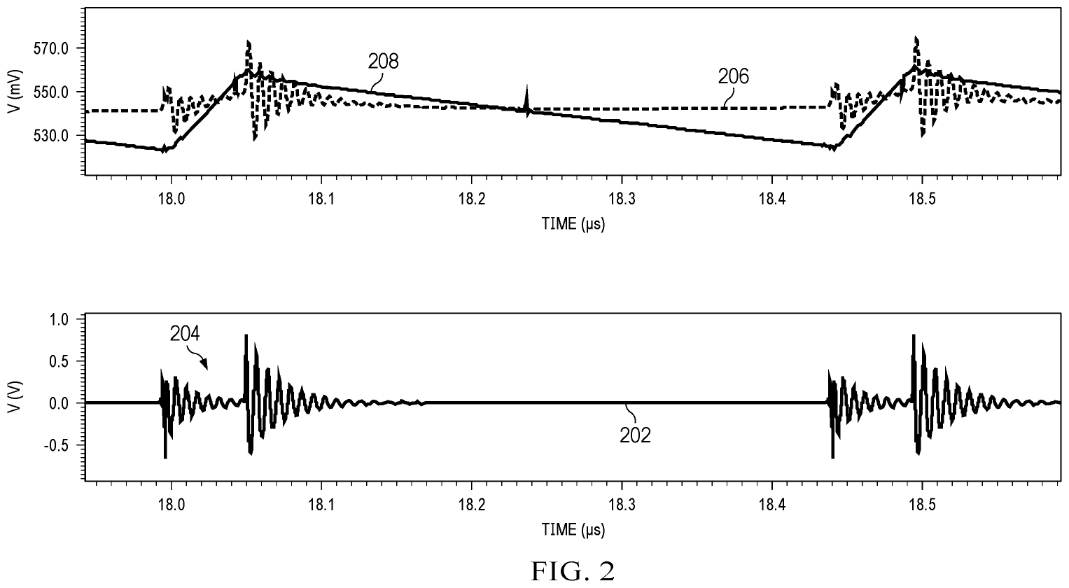

FIG. 2 is a graph of example signals in a switching converter that lacks ground damping (e.g., the switching converter 100 without the resistor 118 and with a short (a very low resistance (e.g., zero ohms) conductor replacing the resistor 120. FIG. 2 shows a signal 202, which is the voltage on the ground terminal 106. Ringing 204 on the signal 202 is caused by switching of the transistor 108 and transistor 110, and oscillation in the tank circuit formed by the parasitic capacitor 124, the parasitic inductor 126, and the parasitic inductor 128. The signals 206 and 208 are generated by circuitry of the controller 112. The controller 112 includes an error amplifier that compares the output voltage of the switching converter 100 (VOUT) to a reference voltage. The signal 206 is the output signal of the error amplifier. The ringing 204 on analog ground causes a similar ringing to appear on the signal 206. The signal 208 is a ramp signal generated by circuitry of the controller 112. The frequency of the ramp signal may be based on a clock signal that sets the switching frequency of the switching converter 100. The controller 112 includes a comparator that compares the signal 208 to the signal 206 to set the duty of cycle of the signals that control switching of the transistor 108 and the transistor 110. If the ringing on the signal 206 triggers the comparator at the wrong time, the duty cycle, and the output voltage of the switching converter 100 may be adversely affected. If the controller 112 applies blanking to avoid triggering the comparator based on the ringing on the signal 206, the blanking time will be relatively long, which limits the duty cycle and the output voltage of the switching converter 100.

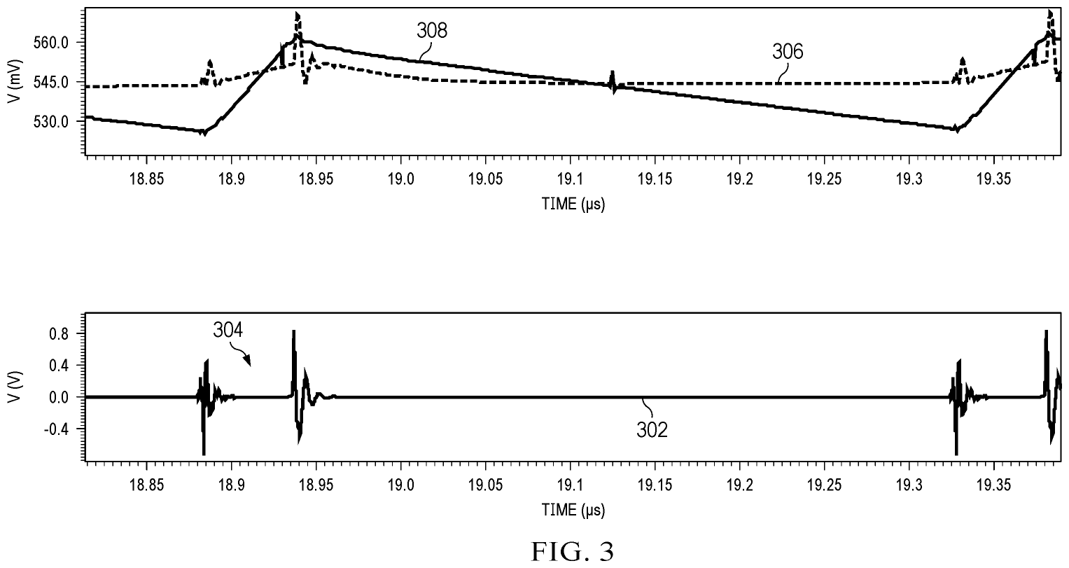

FIG. 3 is a graph of example signals in the switching converter 100. FIG. 3 shows a signal 302, which is the voltage on the ground terminal 106. Ringing 304 on the signal 302 is caused by switching of the transistor 108 and transistor 110, and oscillation in the tank circuit formed by the parasitic capacitor 124, the parasitic inductor 126, and the parasitic inductor 128. Comparing the signal 302 to the signal 202, the ringing 304 has significantly lower duration than the ringing 204 due to the damping provided by the resistor 118 and the resistor 120. The signal 306 is the error signal provided by the error amplifier of the controller 112, and the signal 308 is the ramp signal generated in the controller 112 as described with regard to FIG. 2. Because the ringing 304 is reduced in duration, the ringing on the signal 306 is also reduced in duration (relative to the ringing on the signal 206). As a result, the comparator of the controller 112 is less likely to be triggered by the ringing. If the controller 112 applies blanking to avoid triggering the comparator based on the ringing on the signal 306, the blanking time can be significantly shorter than the blanking time needed with the signal 206. Accordingly, the damping provided by the resistor 118 and the resistor 120 allows the switching converter 100 to implement significantly shorter duty cycles and lower output voltages than switching converters that lack ground damping.

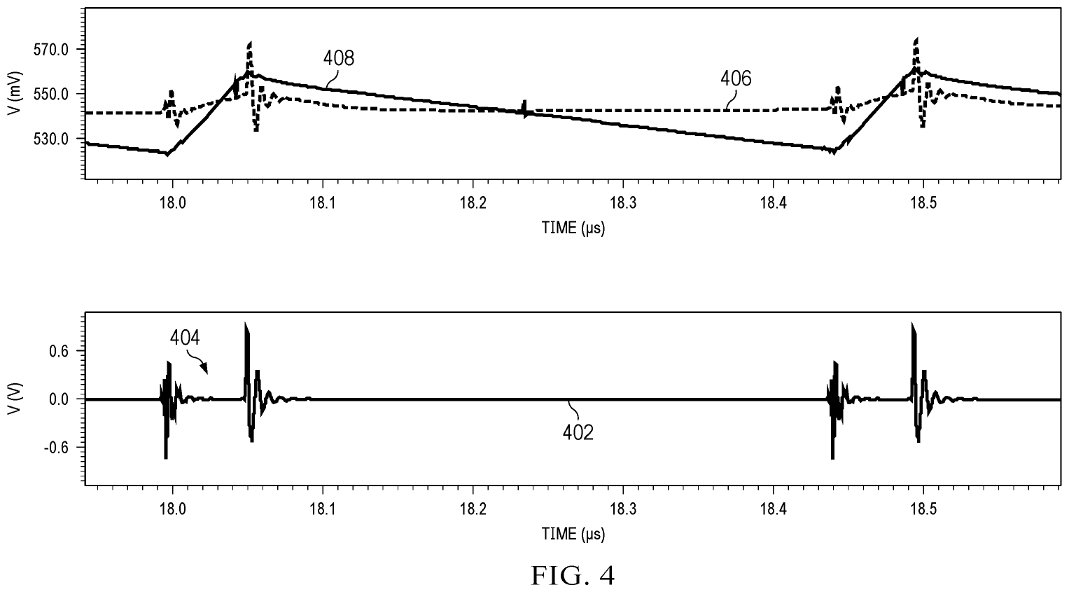

FIG. 4 is a graph of example signals in an implementation of the switching converter 100 that includes the resistor 118 and lacks the resistor 120. FIG. 4 shows a signal 402, which is the voltage on the ground terminal 106. Ringing 404 on the signal 402 is caused by switching of the transistor 108 and transistor 110, and oscillation in the tank circuit formed by the parasitic capacitor 124, the parasitic inductor 126, and the parasitic inductor 128. Comparing the signal 402 to the signal 202, the ringing 404 has significantly lower duration than the ringing 204 due to the damping provided by the resistor 118. The signal 406 is the error signal provided by the error amplifier of the controller 112, and the signal 408 is the ramp signal generated in the controller 112 as described with regard to FIG. 2. Because the ringing 404 is reduced in duration, the ringing on the signal 406 is also reduced in duration (relative to the ringing on the signal 206). As a result, the comparator of the controller 112 is less likely to be triggered by the ringing. If the controller 112 applies blanking to avoid triggering the comparator based on the ringing on the signal 406, the blanking time can be significantly shorter than the blanking time needed with the signal 206. Accordingly, the damping provided by the resistor 118 allows the switching converter 100 to implement significantly shorter duty cycles and lower output voltages than switching converters that lack ground damping.

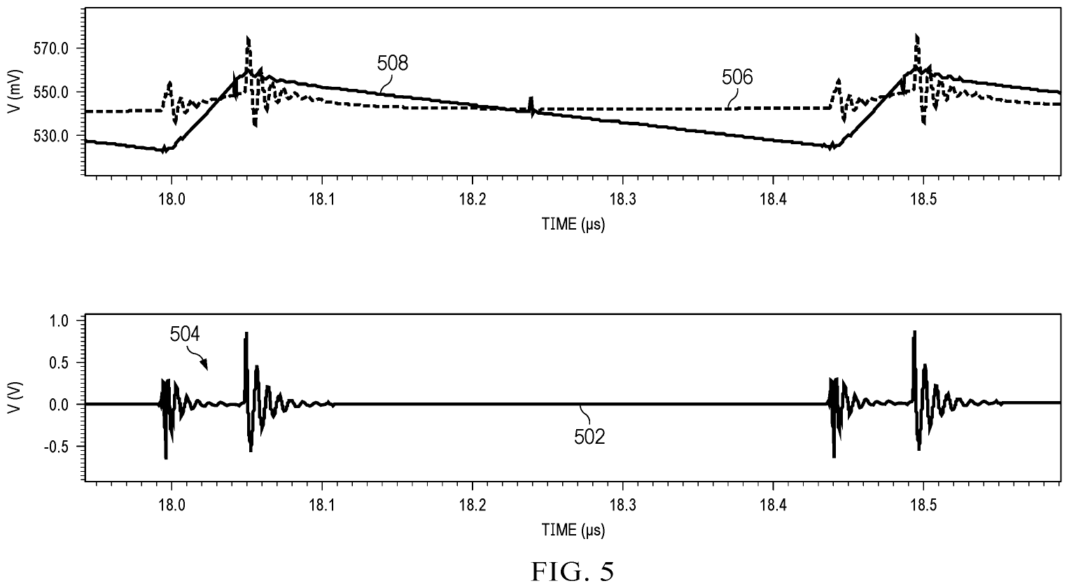

FIG. 5 is a graph of example signals in an implementation of the switching converter 100 that includes the resistor 120 and lacks the resistor 118. FIG. 5 shows a signal 502, which is the voltage on the ground terminal 106. Ringing 504 on the signal 502 is caused by switching of the transistor 108 and transistor 110, and oscillation in the tank circuit formed by the parasitic capacitor 124, the parasitic inductor 126, and the parasitic inductor 128. Comparing the signal 502 to the signal 202, the ringing 504 has significantly lower duration than the ringing 204 due to the damping provided by the resistor 120. The signal 506 is the error signal provided by the error amplifier of the controller 112, and the signal 508 is the ramp signal generated in the controller 112 as described with regard to FIG. 2. Because the ringing 504 is reduced in duration, the ringing on the signal 506 is also reduced in duration (relative to the ringing on the signal 206). As a result, the comparator of the controller 112 is less likely to be triggered by the ringing. If the controller 112 applies blanking to avoid triggering the comparator based on the ringing on the signal 406, the blanking time can be significantly shorter than the blanking time needed with the signal 206. Accordingly, the damping provided by the resistor 120 allows the switching converter 100 to implement significantly shorter duty cycles and lower output voltages than switching converters that lack ground damping.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET)) (p-type transistor)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SiC), a gallium nitride substrate (GaN) or a gallium arsenide substrate (GaAs).

References may be made in the claims to a transistor's control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a first ground terminal and a second ground terminal;
an output terminal configured to provide an output voltage;
a transistor having a first terminal coupled to the output terminal, a second terminal coupled to the first ground terminal, and a control terminal;
a controller having an output coupled to the control terminal, and a reference terminal coupled to the second ground terminal; and
a resistor having a first terminal coupled to the second terminal of the transistor, and a second terminal coupled to the reference terminal.

2. The circuit of claim 1, wherein:
the resistor is a first resistor; and
the circuit includes a second resistor having a first terminal coupled to the second terminal of the first resistor, and a second terminal coupled to the second ground terminal.

3. The circuit of claim 2, wherein:
the first resistor has a resistance of about 5 ohms; and
the second resistor has a resistance of about 0.2 ohms.

4. The circuit of claim 2, wherein:
the first resistor has a resistance in a range of about 3-7 ohms; and
the second resistor has a resistance of about 0.01-0.5 ohms.

5. The circuit of claim 1, further comprising:
a first diode having an anode coupled to the second terminal of the transistor, and a cathode coupled to the reference terminal; and
a second diode having a cathode coupled to the second terminal of the transistor, and an anode coupled to the reference terminal.

6. The circuit of claim 1, wherein:
the transistor is a first transistor;
the output of the controller is a first output;
the controller includes a second output; and
the circuit includes:
an input terminal configured to provide an input voltage; and
a second transistor having a first terminal coupled to the input terminal, a second terminal coupled to the first terminal of the first transistor, and a control terminal coupled to the second output of the controller.

7. The circuit of claim 6, further comprising:
a first driver having an input coupled to the first output of the controller, and an output coupled to the control terminal of the first transistor; and
a second driver having an input coupled to the second output of the controller, and an output coupled to the control terminal of the second transistor.

8. A circuit comprising:
a first ground terminal and a second ground terminal;
an output terminal configured to provide an output voltage;
a transistor having a first terminal coupled to the output terminal, a second terminal coupled to the first ground terminal, and a control terminal;
a controller having an output coupled to the control terminal, and a reference terminal;
anti-parallel diodes coupled between the reference terminal and the second terminal of the transistor; and
a resistor coupled between the reference terminal and the second ground terminal.

9. The circuit of claim 8, wherein the resistor is coupled between the anti-parallel diodes and the second ground terminal.

10. The circuit of claim 8 wherein:
the resistor is a first resistor; and
the circuit includes a second resistor coupled in parallel with anti-parallel diodes between the second terminal of the transistor and the first resistor.

11. The circuit of claim 10, wherein:
the first resistor has a resistance of about 0.2 ohms; and
the second resistor has a resistance of about 5 ohms.

12. The circuit of claim 10, wherein:
the first resistor has a resistance in a range of about 0.01-1 ohms; and
the second resistor has a resistance of about 3-20 ohms.

13. The circuit of claim 8, wherein:
the transistor is a first transistor;
the output of the controller is a first output;
the controller includes a second output; and
the circuit includes a second transistor having a first terminal coupled to an input voltage terminal, a second terminal coupled to the first terminal of the first transistor, and a control terminal coupled to the second output of the controller.

14. The circuit of claim 13, further comprising:
a first driver having an input coupled to the first output of the controller, and an output coupled to the control terminal of the first transistor; and
a second driver having an input coupled to the second output of the controller, and an output coupled to the control terminal of the second transistor.

15. An integrated circuit comprising:
a semiconductor die including:
a first ground terminal;
a second ground terminal;
an output terminal configured to provide an output voltage;
a transistor having a first terminal coupled to the output terminal, a second terminal coupled to the first ground terminal, and a control terminal;
a controller having an output coupled to the control terminal, and a reference terminal;
a first resistor having a first terminal coupled to the second terminal of the transistor, and a second terminal coupled to the reference terminal; and
a second resistor having a first terminal coupled to the reference terminal, and a second terminal coupled to the second ground terminal.

16. The integrated circuit of claim 15, wherein:
the first resistor has a resistance of about 5 ohms; and
the second resistor has a resistance of about 0.2 ohms.

17. The integrated circuit of claim 15, wherein:
the first resistor has a resistance in a range of about 3-20 ohms; and
the second resistor has a resistance of about 0.01-1 ohms.

18. The integrated circuit of claim 15, further comprising:
a first diode having an anode coupled to the second terminal of the transistor, and a cathode coupled to the second terminal of the first resistor; and
a second diode having a cathode coupled to the second terminal of the transistor, and an anode coupled to the second terminal of the first resistor.

19. The integrated circuit of claim 15, wherein:
the transistor is a first transistor;
the output of the controller is a first output;
the controller includes a second output; and
the integrated circuit includes a second transistor having a first terminal coupled to an input voltage terminal, a second terminal coupled to the first terminal of the first transistor, and a control terminal coupled to the second output of the controller.

20. The integrated circuit of claim 19, further comprising:
a first driver having an input coupled to the first output of the controller, and an output coupled to the control terminal of the first transistor; and
a second driver having an input coupled to the second output of the controller, and an output coupled to the control terminal of the second transistor.
